(19) United States
(12) Patent Application Publication
(10) Pub. No.: US 2011/0067969 A1
(43) Pub. Date: Mar. 24, 2011

(54) NON-ROTATING CLUTCH

(75) Inventors: William S. Reed, Greenfield, IN (US); Gregory W. Kempf, Avon, IN (US); Douglas Scott Burchett, Indianapolis, IN (US)

(73) Assignee: GM GLOBAL TECHNOLOGY OPERATIONS, INC., Detroit, MI (US)

(21) Appl. No.: 12/564,067

(22) Filed: Sep. 22, 2009

(51) Int. Cl. F16D 67/02

(52) U.S. Cl. 192/14

(57) ABSTRACT

A grounded clutch mechanism for a transmission includes a transmission housing and a backing plate fixedly secured to the transmission housing. The backing plate has a plurality of backing plate posts. A plurality of reaction plates have a plurality of radially-outward spline teeth configured to mate with the backing plate posts. Torque may be transferred between the backing plate and the reaction plates. The reaction plates do not transfer torque directly to the transmission housing. The backing plate may be radially symmetric with respect to an axis of rotation. A plurality of clutch plates may be configured to selectively transfer torque to the reaction plates. The clutch plates may be configured to be selectively rotatable with respect to the axis of rotation and the reaction plates are configured not to be rotatable with respect to the axis of rotation.

### TECHNICAL FIELD

This disclosure relates to torque transmitting mechanisms for transmissions.

### BACKGROUND OF THE INVENTION

Clutches are mechanisms for transmitting rotation, which can be engaged and disengaged. Friction clutches may have two sets of interleaved plates which are pressed into frictional engagement when actuated, causing common rotation (or lack of rotation, depending upon the viewpoint) between the sets of plates and members attached thereto. Generally, engagement allows torque to be transferred across the clutch, and disengagement does not allow torque transfer.

### SUMMARY

A grounded clutch mechanism for a transmission is provided. The mechanism includes a transmission housing and a backing plate fixedly secured to the transmission housing. The backing plate has a plurality of backing plate posts. A plurality of reaction plates have a plurality of radially-outward spline teeth, which are configured to mate with the backing plate posts. Torque may be transferred between the backing plate and the reaction plates via the backing plate posts and the radially-outward spline teeth. The reaction plates do not transfer torque directly to the transmission housing. The transmission may have an axis of rotation defined therethrough, and the backing plate may be radially symmetric with respect to the axis of rotation.

The clutch mechanism may further include a plurality of clutch plates configured to selectively transfer torque to the plurality of reaction plates. The clutch plates may be configured to be selectively rotatable with respect to the axis of rotation and the reaction plates are configured not to be rotatable with respect to the axis of rotation. The backing plate may be formed from a ferritic material, and may be formed by a powdered metallurgy process.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic lever diagram illustration of an exemplary vehicle powertrain with a multi-mode, electrically-variable hybrid transmission in accordance with the present invention;

FIG. 2 is a schematic, side cross-sectional view of a non-rotating clutch and planetary gearset within the transmission; and

FIG. 3 is a schematic, partial exploded perspective view of the non-rotating clutch and transmission housing.

### DESCRIPTION OF PREFERRED EMBODIMENTS

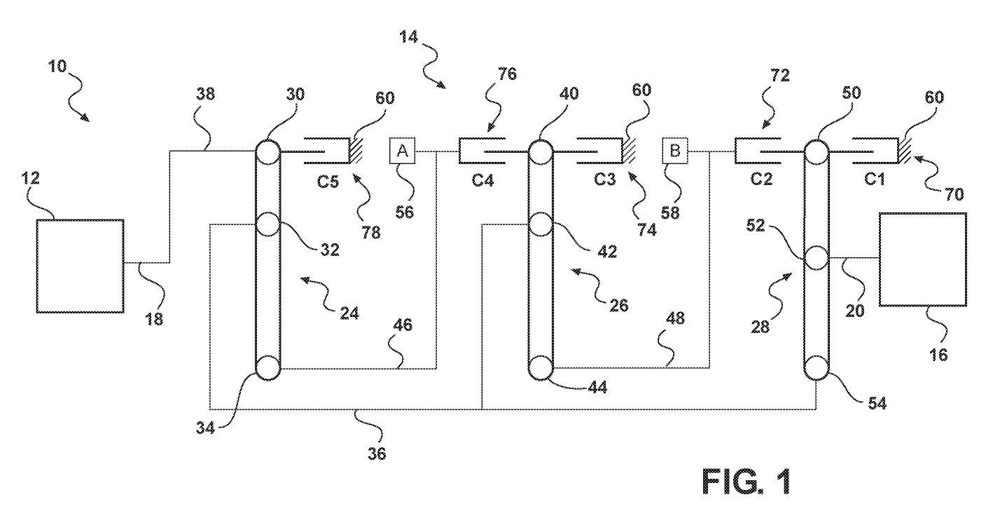

Referring to the drawings, wherein like reference numbers refer to like components throughout the several views, there is shown in FIG. 1 a stick or lever diagram depiction of an exemplary vehicle powertrain system, designated generally as 10. The powertrain 10 includes a restartable engine 12 that is selectively drivingly connected to, or in power flow communication with, a final drive system 16 via a multi-mode, electrically-variable hybrid-type power transmission 14.

Those having ordinary skill in the art will recognize that a lever diagram is a schematic representation of the components of a mechanical device such as a transmission. Each individual lever represents a planetary gearset, wherein the three basic mechanical components of the planetary gear are each represented by a node. Therefore, a single lever contains three nodes: one for the sun gear member, one for the planet gear carrier member, and one for the ring gear member. The relative length between the nodes of each lever may be used to represent the ring-to-sun ratio of each respective gearset. These lever ratios, in turn, are used to vary the gear ratios of the transmission in order to achieve appropriate ratios and ratio progression.

Mechanical couplings or interconnections between the nodes of the various planetary gear sets and other components of the transmission (such as motor/generators) are illustrated by thin, horizontal lines. Torque transmitting mechanisms such as clutches and brakes are presented as interleaved fingers. If the mechanism is a brake, one set of the fingers is grounded, or static.

The claimed invention is described herein in the context of a hybrid-type vehicular powertrain having a multi-mode, multi-speed, electrically-variable, hybrid transmission, which is intended solely as an illustrative application into which the present invention may be incorporated. The claimed invention is not limited to the particular powertrain arrangement shown in the drawings. Furthermore, the hybrid powertrain illustrated herein has been greatly simplified, as will be recognized by those having ordinary skill in the art.

The transmission 14 is designed to selectively receive at least a portion of its driving power from the engine 12, through an input member 18, for example. The transmission input member 18, which is in the nature of a shaft, may be the engine output shaft (also referred to as a “crankshaft”). Alternatively, a damper (not shown) may be implemented between the engine 12 and the input member 18 of the transmission 14. The engine 12 transfers power to the transmission 14, which distributes torque through a transmission output member or shaft 20 to drive the final drive system 16, and thereby propel the vehicle (not shown).

In the powertrain 10 depicted in FIG. 1, the engine 12 may be any of numerous forms of internal combustion engines, which includes spark-ignited gasoline engines and compression-ignited diesel engines. The engine 12 is readily adaptable to provide its available power to the transmission 14 at a range of operating speeds.

Referring still to FIG. 1, the hybrid transmission 14 utilizes one or more differential gear arrangements, such as three interconnected epicyclic planetary gear sets, designated generally at 24, 26 and 28, respectively. The first, second, and third gear sets 24, 26, and 28, may alternatively be referred to as P1, P2, and P3, respectively. Each gear set includes three gear members: a first, second and third member.

The first, second and third gear sets may be counted “first” to “third” in any order in the drawings (e.g., left to right, right to left, etc.). Similarly, the first, second and third members of each gear set may be counted or identified as “first” to “third” in any order for each gear set in the drawings (e.g., top to bottom, bottom to top, etc.), in this description, and in the claims.

The first planetary gear set 24 has three gear members: a first, second and third member 30, 32 and 34; respectively. The first, second and third members may correspond to the first, second and third nodes of the lever diagram shown in FIG. 1, as viewed from top to bottom. The first member is an outer gear member (which may be referred to as a ring gear) that circumscribes the third member 34, which may include an inner gear member (which may be referred to as a sun gear).

The second member 32 is a planet carrier. A plurality of planetary gear members (which may be referred to as pinion gears or planets) are rotatably mounted on the second member, planet carrier 32. Through the planetary gear members, the planet carrier 32 is meshingly, or drivingly, engaged with both ring gear 30, and sun gear 34.

The second planetary gear set 26 also includes three gear members: a first, second and third member 40, 42 and 44, respectively. The first member is a ring gear 40 which circumscribes the third member, a sun gear 44. The ring gear 40 is coaxially aligned and rotatable with respect to the sun gear 44. A plurality of planetary gear members are rotatably mounted on the second member, a planet carrier 42, such that planet carrier 42 meshingly engages both the ring gear 40 and the sun gear 44.

The third planetary gear set 28, similar to the first and second gear sets 24, 26, also has first, second and third members 50, 52 and 54, respectively. In this arrangement, however, the second member 52, shown on the middle node of the lever representing the third planetary gear set 28, is the outer, ring gear. The ring gear 52 is coaxially aligned and rotatable with respect to the third member, sun gear 54. The first member is a planet carrier 50 in this particular gear set, and is shown on the top node. A plurality of planetary or pinion gear members are rotatably mounted on the planet carrier 50. Each of the pinion gear members is aligned to meshingly engage either the ring gear 52 and an adjacent pinion gear member or the sun gear 54 and an adjacent pinion gear member.

In the powertrain 10 shown in FIG. 1, the first and second planetary gear sets 24, 26 are simple planetary gear sets, whereas the third planetary gear set 28 is a compound planetary gear set. However, as will be recognized by those having ordinary skill in the art each of the planet carrier members described above can be either a single-pinion (simple) carrier assembly or a double-pinion (compound) carrier assembly. Embodiments with long pinions are also possible.

The first, second and third planetary gear sets 24, 26, 28 are compounded in that the second member 32 of the first planetary gear set 24 is connected to the second member 42 of the second planetary gear set 26 and the third member 54 of the third planetary gear set 28 by a central shaft 36. As such, these three gear members 32, 42, 54 are rigidly attached for common rotation.

The engine 12 is continuously connected to the first member 30 of the first planetary gear set 24 by, for example, an integral hub plate 38, for common rotation therewith. The third member 34 of the first planetary gear set 24 is continuously connected, for example, by a first sleeve shaft 46, to a first motor/generator assembly 56, which is also referred to herein as “motor A”. The third member 44 of the second planetary gear set 26 is continuously connected, for example, by a second sleeve shaft 48, to a second motor/generator assembly 58, also referred to herein as “motor B”. The second member 52 (the ring gear) of the third planetary gear set 28 is continuously connected to transmission output member 20 through, for example, an integral hub plate. The first and second sleeve shafts 46, 48 may circumscribe the central shaft 36.

A first torque transmitting mechanism 70—which is herein interchangeably referred to as clutch C1—selectively connects the first gear member 50 with a stationary member. The stationary member may be a transmission housing 60, or may have an indirect connection to the transmission housing 60 or some other grounded object within the powertrain 10. The second sleeve shaft 48, and thus third member 44 and motor/generator 58, is selectively connectable to the first member 50 of the third planetary gear set 28 through the selective engagement of a second torque transmitting mechanism 72—which is herein interchangeably referred to as clutch C2.

A third torque transmitting mechanism 74—which is herein interchangeably referred to as clutch C3—selectively connects the first gear member 40 of the second planetary gear set 26 to the transmission housing 60 or another stationary member. The first sleeve shaft 46, and thus third gear member 34 and first motor/generator 56, is also selectively connectable to the first member 40 of the second planetary gear set 26, through selective engagement of a fourth torque transmitting mechanism 76—which is herein interchangeably referred to as clutch C4.

A fifth torque transmitting mechanism 78—which is herein interchangeably referred to as clutch C5—selectively connects the input member 18 of engine 12 and the first gear member 30 of the first planetary gear set 24 to the transmission housing 60 or another stationary member. Clutch C5 is an input brake clutch, which selectively locks the input member 18 when engine 12 is off. Locking input member 18 provides more reaction for regenerative braking energy.

The first and second torque transmitting mechanisms 70, 72 (C1 and C2) may be referred to as “output clutches.” The third and fourth torque transmitting mechanisms 74, 76 (C3 and C4) may be referred to as “holding clutches”. The term “clutch” may be used to refer generally to any of the torque transmitting mechanisms, including, without limitation, devices commonly referred to as clutches, brakes, non-rotating or grounded clutches, et cetera.

In the exemplary embodiment depicted in FIG. 1, the various torque transmitting mechanisms 70, 72, 74, 76, 78 (C1-C5) are all friction clutches. However, other conventional clutch configurations may be employed, such as dog clutches, rocker clutches, and others recognizable to those having ordinary skill in the art. The clutches C1-C5 may be hydraulically actuated, receiving pressurized hydraulic fluid from a pump (not shown). Hydraulic actuation of clutches C1-C5 is accomplished, for example, by using a conventional hydraulic fluid control circuit, as will be recognized by one having ordinary skill in the art.

The planetary gear sets 24, 26, 28, as well as the first and second motor/generators 56, 58 (motors A and B) are coaxially oriented about the intermediate central shaft 36, which forms an axis of rotation 37 for the transmission 14. Motor A or motor B may take on an annular configuration, permitting one or both to generally circumscribe the three planetary gear sets 24, 26, 28 and the axis of rotation 37.

The hybrid transmission 14 receives torque from a plurality of torque-generative devices. “Torque-generative devices” include the engine 12 and the motors/generators 56, 58 as a result of energy conversion from fuel stored in a fuel tank or electrical potential stored in an electrical energy storage device (neither of which is shown).

The engine 12, motor A (56) and motor B (58) may operate individually or in concert—in conjunction with the planetary gear sets and selectively-engageable torque-transmitting mechanisms—to rotate the transmission output shaft 20. Moreover, motor A and motor B are preferably configured to selectively operate as both a motor and a generator. For example, motor A and motor B are capable of converting electrical energy to mechanical energy (e.g., during vehicle propulsion), and further capable of converting mechanical energy to electrical energy (e.g., during regenerative braking or during periods of excess power supply from engine 12).

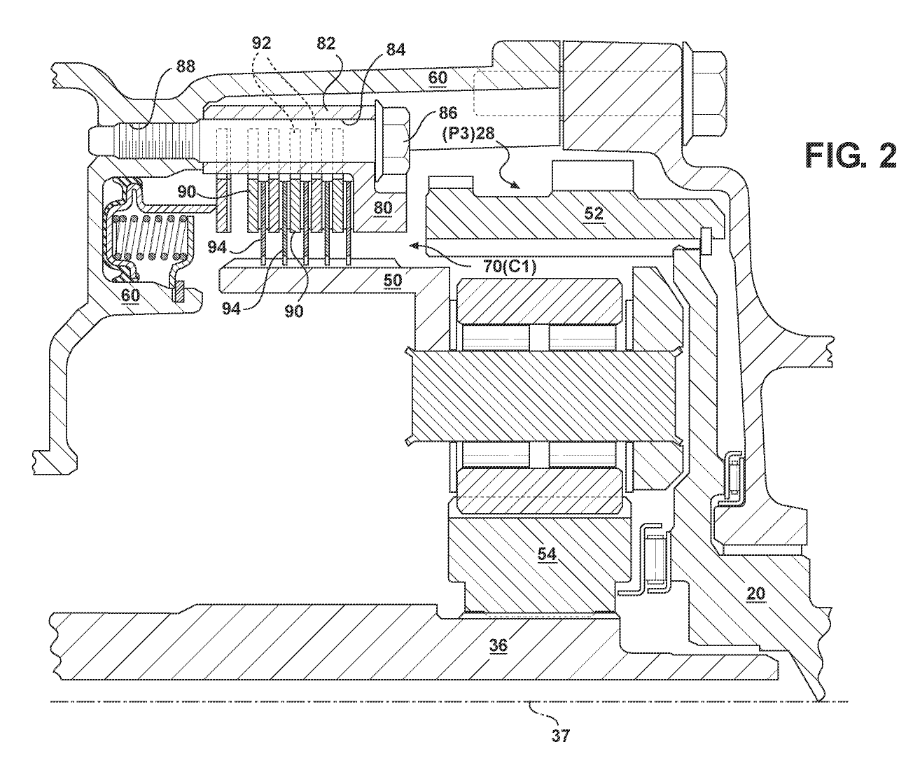

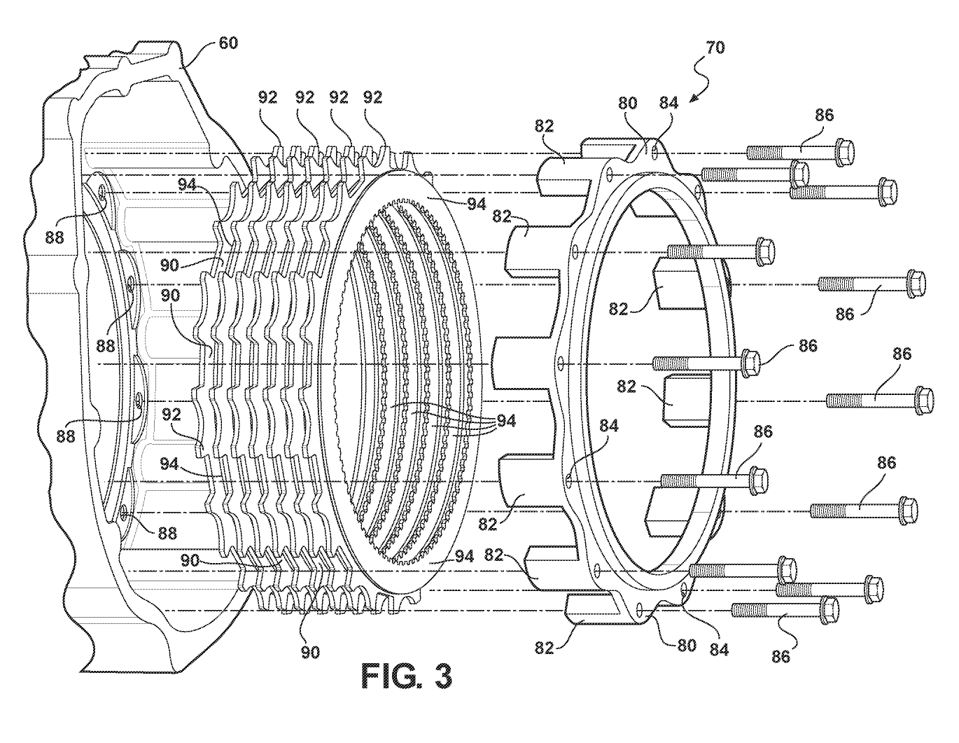

Referring now to FIGS. 2 and 3, and with continued reference to FIG. 1, there are shown two partial views of the interior of transmission 14. FIG. 2 shows a schematic side view of the first torque transmitting mechanism 70, C1, and the third planetary gearset 28 within the transmission 14. FIG. 3 shows a partial exploded view of the clutch C1.

In the transmission 14, C1 is the rear non-rotating clutch—a clutch with non-rotating reaction plates, also referred to as a brake, grounded clutch, or grounded torque transmitting mechanism. In powertrain 10, C1 may experience torque reversals under certain conditions. For example, and without limitation: a throttle position change from partial throttle to no throttle during a low speed, down-grade vehicle maneuver will reverse the torque direction on the applied clutch C1.

The clutch C1 includes a backing plate 80 which is fixedly secured to the transmission housing 60. A pattern or plurality of backing plate posts 82 extend in the axial direction from the backing plate 80, toward the transmission housing 60. A plurality of bolt holes 84 are defined axially through the plurality of backing plate posts 82. The bolt holes 84 may be configured to pass through the middle or center of the backing plate posts 82. A plurality of backing plate bolts 86 pass through the bolt holes 84 and thread into threaded holes 88 in the transmission housing 60, such that the backing plate 80 can be rigidly attached to the transmission housing 60.

The backing plate posts 82 serve to set the axial position of the backing plate 80 to the transmission housing 60, eliminating the need for a retaining ring to hold the backing plate 80 relative to the remainder of clutch C1. A plurality of reaction plates 90 are located between the backing plate posts 82. The reaction plates 90 have a plurality of radially-outward spline teeth 92.

Since the backing plate 80 is bolted to the transmission housing 60, and is therefore a static (non-rotating) object, the radially-outward spline teeth 92 can be mated directly to the backing plate posts 82. Once assembled, the reaction plates 90 are splined to the backing plate posts 82, in lieu of being splined to teeth formed on the interior of the transmission housing 60. Therefore, the reaction plates 90 are grounded by the backing plate 80, as opposed to the transmission housing 60, and torque may be transferred between the backing plate 80 and reaction plates 90.

A plurality of clutch plates 94 rotate in common with the planet carrier 50 of the third planetary gearset 28. In operation of the transmission 10, actuation of C1 causes the clutch plates 94 to transfer torque to the plurality of reaction plates 90. Therefore, actuation of the clutch plates 94 cause the planet carrier 50 to become grounded by the backing plate 80 and to stop rotating relative to the transmission housing 60.

The backing plate 80 is radially symmetric with respect to the axis of rotation 37. Therefore, the backing plate posts 82, bolt holes 84, and radially-outward spline teeth 92 are on a repetitive symmetrical pattern. FIG. 3 shows a radially-symmetric pattern of, for example, and without limitation: twelve backing plate posts 82, twelve bolt holes 84, and twelve radially-outward spline teeth 92. The reaction plates are also axially symmetric, so the reaction plates 90 can be assembled in to the backing plate 80 in any of 24 orientations (twelve radial rotations and two axial directions). Furthermore, the backing plate 80 (with the clutch plates 94 and reaction plates 90 already in place) can be assembled in any of twelve orientations into the transmission housing 60.

Those having ordinary skill in the art will recognize that different patterns and different numbers of elements may be used, depending upon the exact design. Furthermore, those having ordinary skill in the art will recognize that absolute symmetry is not required (manufacturing imperfections may occur, for example).

An alternative non-rotating clutch (not shown) may be directly grounded to the transmission housing 60 by a pattern of external spline teeth on the reaction plates and internal spline teeth formed directly on the transmission housing 60. These internal spline teeth may be cast into the transmission housing 60 or machined into the transmission housing 60 after the casting process.

The backing plate 80 may be formed from of a ferrite material, and may be formed by (for example, and without limitation) a powdered metallurgy process. The relative strength of ferritic materials forming the backing plate 80 as compared to the aluminum forming the transmission housing 60 may require fewer radially-outward spline teeth 92 to react the clutch torque. Furthermore, the thickness of the reaction plates 90 may be reduced, as less area is required to distribute stress between the radially-outward spline teeth 92 and the static member.

Torque reversals on non-rotating clutch cause the radially-outward spline teeth 92 to transfer torque from one backing plate post 82 to another. If the internal spline teeth were formed on the transmission housing 60, this torque transfer may cause the radially-outward spline teeth 92 to travel from their clockwise seat position against the internal spline teeth to their counter-clockwise position against the internal spline teeth, or vice versa. This travel of reaction plates is termed backlash or snap, and may cause vibrations at the interfaces between the backing plate posts 82 and the radially-outward spline teeth 92, resulting in radiated audible noise outside of the transmission 14.

The clearance between the internal spline teeth—either those incorporated into the backing plate posts 82 or on the interior of transmission housing 60—and the spline teeth of the reaction plates 90 determines the amount of travel during torque reversals, and may, therefore, affect the amount of noise energy generated during the same event. In alternative configurations, the torque reversals of the reaction plates may also rotate the clutch backing plate, which is simply an axial space-holder and support held in place by a retaining ring.

Forming the backing plate posts 82 from powdered metal does not require casting draft and may have a lower location tolerance requirement than the aluminum transmission housing 60, which is likely a die-cast component. By reducing the location tolerance between the radially-outward splines and the interior splines—which are formed on the backing plate posts 82 in this clutch C1—reduces the amount of the backlash and the noise levels in the non-rotating clutch. Furthermore, since the non-rotating splines are on an internal component—the backing plate posts 82 of the backing plate 80, as opposed to an external component, the transmission housing 60—the noise radiated outside of the transmission 14 may be reduced due to damping characteristics of the components as vibration travels through to the external transmission housing 60.

The present invention is described in detail with respect to automotive applications; however, those skilled in the art will recognize the broader applicability of the invention. Those having ordinary skill in the art will further recognize that terms such as “above,” “below,” “upward,” “downward,” et cetera, are used descriptively of the figures, and do not represent limitations on the scope of the invention, as defined by the appended claims. While the best modes and other embodiments for carrying out the claimed invention have been described in detail, those familiar with the art to which this invention relates will recognize various alternative designs and embodiments for practicing the invention within the scope of the appended claims.

1. A grounded clutch mechanism for a transmission, comprising:
a transmission housing;
a backing plate fixedly secured to said transmission housing and having a plurality of backing plate posts;
a plurality of reaction plates having a plurality of radially-outward spline teeth, wherein said plurality of radially-outward spline teeth are configured to mate with the plurality of backing plate posts, such that torque may be transferred between said backing plate and said plurality of reaction plates; and
wherein said plurality of reaction plates do not transfer torque directly to said transmission housing.

2. The clutch mechanism of claim 1, wherein the transmission includes an axis of rotation and wherein said backing plate is radially symmetric with respect to said axis of rotation.

3. The clutch mechanism of claim 2, further comprising a plurality of clutch plates, wherein said plurality of clutch plates are configured to selectively transfer torque to said plurality of reaction plates.

4. The clutch mechanism of claim 3, wherein said plurality of clutch plates are configured to be selectively rotatable with respect to said axis of rotation and said plurality of reaction plates are configured not to be rotatable with respect to said axis of rotation.

5. The clutch mechanism of claim 4, wherein the clutch mechanism is further characterized by the absence of a retaining ring configured to prevent movement of said backing plate axially with respect to said axis of rotation.

6. The clutch mechanism of claim 5, further comprising:
a plurality of bolt holes defined axially through said plurality of backing plate posts; and
a plurality of bolts, wherein said backing plate is bolted to said transmission housing through said plurality of bolt holes.

7. The clutch mechanism of claim 6, wherein said backing plate is formed from a ferritic material.

8. The clutch mechanism of claim 6, wherein said backing plate is formed by a powdered metallurgy process.

9. A grounded clutch mechanism for a transmission, comprising:
a transmission housing;
a backing plate fixedly secured to said transmission housing and having a plurality of backing plate posts;
a plurality of bolt holes defined axially through said plurality of backing plate posts;
a plurality of bolts, wherein said backing plate is bolted to said transmission housing through said plurality of bolt holes;
a plurality of reaction plates having a plurality of radially-outward spline teeth, wherein said plurality of radially-outward spline teeth are configured to mate with the plurality of backing plate posts, such that torque may be transferred between said backing plate and said plurality of reaction plates; and
wherein said plurality of reaction plates do not transfer torque directly to said transmission housing.

10. The clutch mechanism of claim 9, wherein the transmission includes an axis of rotation and wherein said backing plate is radially symmetric with respect to said axis of rotation.

11. The clutch mechanism of claim 10, wherein the clutch mechanism is further characterized by the absence of a retaining ring configured to prevent movement of said backing plate axially with respect to said axis of rotation.

12. The clutch mechanism of claim 11, further comprising a plurality of clutch plates, wherein said plurality of clutch plates are configured to selectively transfer torque to said plurality of reaction plates.

13. The clutch mechanism of claim 12, wherein said plurality of clutch plates are configured to be selectively rotatable with respect to said axis of rotation and said plurality of reaction plates are configured not to be rotatable with respect to said axis of rotation.
